(19) United States
(12) Patent Application Publication
(10) Pub. No.: US 2015/0303821 A1
(43) Pub. Date: Oct. 22, 2015

(54) WALL SOCKET

(71) Applicant: POWERTECH INDUSTRIAL CO., LTD., New Taipei City (TW)

(72) Inventors: YU-LUNG LEE, New Taipei City (TW); CHI FENG CHENG, New Taipei City (TW)

(21) Appl. No.: 14/335,985

(22) Filed: Jul. 21, 2014

(30) Foreign Application Priority Data
Apr. 21, 2014 (TW) 103206911

(51) Int. Cl. H02M 7/04; H01R 13/66; H01R 24/76

(52) U.S. Cl. CPC H02M 7/04; H01R 24/76; H01R 13/665; H01R 2105/00

(57) ABSTRACT

A wall socket includes a main body and a socket panel. The main body includes a socket portion. The socket portion includes an AC output area and a DC output area. The DC output area is disposed with at least two DC output sockets. The AC output area is disposed with a two-hole socket and a three-hole socket. The socket panel is disposed on the body and has an opening to expose the socket portion. The AC output area and the DC output area are arranged horizontally side by side. The two-hole socket is disposed between the DC output sockets and the three-hole socket.

### BACKGROUND

1. Technical Field

The present disclosure relates to a wall socket, in particular, to a wall socket for supplying DC power and AC power.

2. Description of Related Art

As technology advances, various electronic devices, such as smart phones, laptops, digital cameras, and personal digital assistants (PDA), have been successively invented. The electronic devices bring huge convenience to people's lives. However, most of the electronic devices need DC power to operate, and the power supplied by the traditional power socket (e.g. two-hole socket or three-hole socket) is 110V or 220V AC. Therefore, it is necessary for users of electronic devices to use an AC/DC converter to convert AC power into DC power so that the electronic devices receive converted DC power to operate.

It is worth noting that the electronic devices are usually manufactured by difference companies. So, if people buy two or more different electronic devices, people will get two or more different AC/DC converters. But, it is not convenient for people to charge different electronic devices by using different AC/DC converters.

Moreover, if one of the AC/DC converters is broken or becomes loosened, the user must buy a new one to replace the broken or loosened one, or the user could not charge the electronic device which corresponds to the broken or loosened AC/DC converter.

Accordingly, USB wall sockets have been invented for people to supply DC power to the electronic devices directly and not through AC/DC converters. Further, some USB wall sockets include an indicator to remind people whether the USB wall socket is supplying DC power to an electronic device. However, the traditional USB wall socket commonly includes two or more USB sockets for supplying DC power to two or more electronic devices, and there is a signal indicator disposed on the USB wall socket. Therefore, the signal indicator cannot be used for indicating which USB socket is being used for supplying DC power to an electronic device and which USB socket is not being used for supplying DC power to an electronic device.

### SUMMARY

An exemplary embodiment of the present disclosure provides a wall socket that includes a DC output socket and an AC output socket, for supplying DC power and AC power. It makes it convenient for users to supply DC power and AC power to different electronic devices.

An exemplary embodiment of the present disclosure provides a wall socket including a main body and a socket panel. The main body includes a socket portion. The socket portion includes an AC output area and a DC output area. The DC output area is disposed with at least two DC output sockets. The AC output area is disposed with a two-hole socket and a three-hole socket. The socket panel is disposed on the body and has an opening to expose the socket portion. The AC output area and the DC output area are arranged horizontally side by side. The two-hole socket is disposed between the DC output sockets and the three-hole socket.

According to one exemplary embodiment of the present disclosure, the main body has a receiving portion to accommodate a power module. The power module comprises an alternating current (AC) to direct current (DC) converting unit, a driving circuit, and a control unit. The AC to DC converting unit is coupled to an AC power terminal and configured for transmitting a DC power to the DC output sockets. The driving circuit is coupled to a plurality of indicators and configured for driving the indicators. The control unit is coupled to the AC to DC converting unit and the driving circuit, and the control unit is configured for controlling the indicators according to a power state of the DC output sockets.

An exemplary embodiment of the present disclosure provides a wall socket including a main body and a socket panel. The main body includes a socket portion. The socket portion includes an AC output area and a DC output area. The DC output area is disposed with at least four DC output sockets. The AC output area is disposed with a three-hole socket. The socket panel is disposed on the body and has an opening to expose the socket portion. The AC output area and the DC output area are arranged horizontally side by side. The two-hole socket is disposed between the DC output sockets and the three-hole socket.

In summary, exemplary embodiments of the present disclosure provide a wall socket including DC output sockets and AC output sockets in order to supply DC power and AC power to different electronic devices. It makes it convenient for users to supply DC power to electronic devices directly through the wall socket and not through any AC/DC converter. Moreover, the socket panel of the wall socket is disposed with a plurality of indicators, and each of the indicators corresponds to each of the DC output sockets in one-to-one relationship. The indicators are turned on when the corresponding DC output sockets supplies DC power to an electronic device.

In order to further understand the techniques, means and effects of the present disclosure, the following detailed descriptions and appended drawings are hereby referred to, such that, and through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a schematic diagram of the wall socket in accordance with an embodiment of the instant disclosure;

FIG. 2 is a schematic diagram illustrating a power module connected to a plurality of indicators and a plurality of DC output sockets in accordance with an embodiment of the instant disclosure;

FIG. 3 is a schematic diagram of the wall socket in accordance with another embodiment of the instant disclosure;

FIG. 4 is a schematic diagram illustrating a power module connected to a plurality of indicators and a plurality of DC output sockets in accordance with another embodiment of the instant disclosure;

### DESCRIPTION OF THE EXEMPLARY EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

It should be understood that the usage of “first”, “second” and “third” intends to distinguish one element from another, and the element should not be limited by the term. Therefore, hereinafter a first element is interchangeable with a second element. The term “and/or” includes one and one or more of the combination in the group as described.

### An Embodiment of the Wall Socket

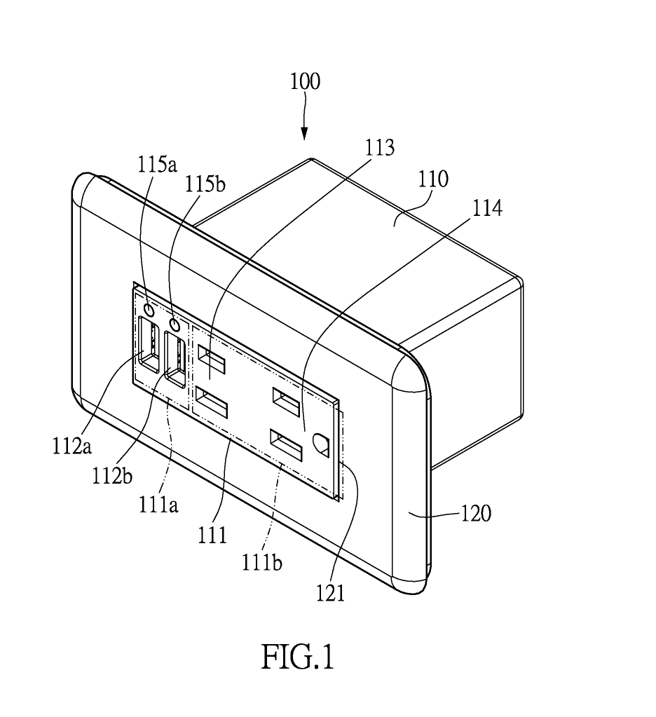

Please refer to FIG. 1, which shows a schematic diagram of the wall socket in accordance with the embodiment of the instant disclosure. The wall socket 100 includes a main body 110 and a socket panel 120. The main body 110 includes a socket portion 111. The socket portion 111 includes a DC output area 111a and an AC output area 111b. The wall socket 100 is configured for supplying DC power and AC power to operate different electronic devices.

Specifically, the DC output area 111a is disposed with at least two DC output sockets, such as DC output sockets 112a and 112b. The DC output sockets 112a and 112b are universal serial bus (USB) sockets. In addition, the DC output area 111a is further disposed with at least two indicators, such as indicators 115a and 115b. The indicator 115a and 115b may be a light emitting diode (LED) or a plurality of LEDs. The indicator 115a is disposed above the DC output socket 112a, and the indicator 115b is disposed above the DC output socket 112b. The indicators 115a and 115b respectively correspond to the DC output sockets 112a and 112b in one-to-one relationship. In the instant embodiment, the wall socket 100 includes two or more indicators and DC output sockets, and the ratio of indicators to DC output sockets is 1:1.

The AC output area 111b is disposed with AC output sockets, such as a two-hole socket 113 and a three-hole socket 114. It is worth noting that the DC output area 111a and the AC output area 111b are arranged horizontally side by side, and the DC output area 111b is smaller than the AC output area 111a. In addition, the two-hole socket 113 is disposed between two DC output sockets 112a, 112b and the three-hole socket 114.

The socket panel 120 is disposed on the main body 110 and has an opening 121, wherein the socket portion 111 is fixedly mounted in the opening 121 and exposed from the opening 121.

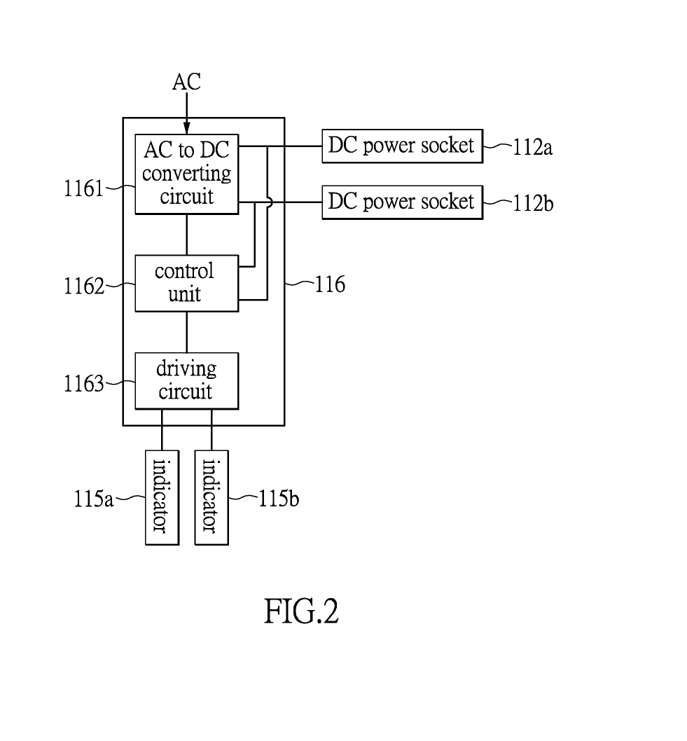

More specifically, please refer to FIG. 1 and FIG. 2, which shows a schematic diagram illustrating a power module connected to a plurality of indicators and a plurality of DC output sockets in accordance with the embodiment of the instant disclosure. The socket portion 110 has a receiving portion to accommodate a power module 116. The power module 116 includes an alternating current (AC) to direct current (DC) converting unit 1161, a control unit 1162, and a driving circuit 1163. The AC to DC converting unit 1161 is coupled to an AC power terminal (not shown), the DC output socket 112a, and the DC output socket 112b. The AC to DC converting unit 1161 is configured for receiving AC power from the AC power terminal and converting the AC power into DC power to the DC output sockets 112a and 112b. In this way, when an electronic device is connected to the DC output socket 112a or the DC output socket 112b, the DC output socket 112a or the DC output socket 112b correspondingly supplies the DC power to the electronic device connected.

The driving circuit 1163 is coupled to the indicators 115a and 115b, and the driving circuit 1163 is configured for driving the indicators 115a and 115b to be turned on or off. The control unit 1162 is coupled to the AC to DC converting unit 1161, the driving circuit 1163, and the DC output sockets 112a and 112b. The control unit 1162 receives power from the AC to DC converting unit 1161 to operate, and the control unit 1162 is configured for controlling the driving circuit 1163 to drive the indicators 115a and 115b according to a power state of the DC output sockets 112a and 112b. It is worth noting that there are two or more indicators and DC output sockets disposed on the wall socket 100 and the ratio of indicators to DC output sockets is 1:1.

More specifically, when an electronic device is connected to the DC output socket 112a to receive the DC power from the DC output socket 112a, the control unit 1162 controls the driving circuit 1163 to turn on the indicators 115a. On the other hand, when an electronic device is connected to the DC output socket 112b to receive the DC power from the DC output socket 112b, the control unit 1162 controls the driving circuit 1163 to turn on the indicators 115b. In this way, the wall socket 100 with two or more indicators can correctly remind the user which DC output socket is used for supplying DC power to an electronic device.

### Another Embodiment of the Wall Socket

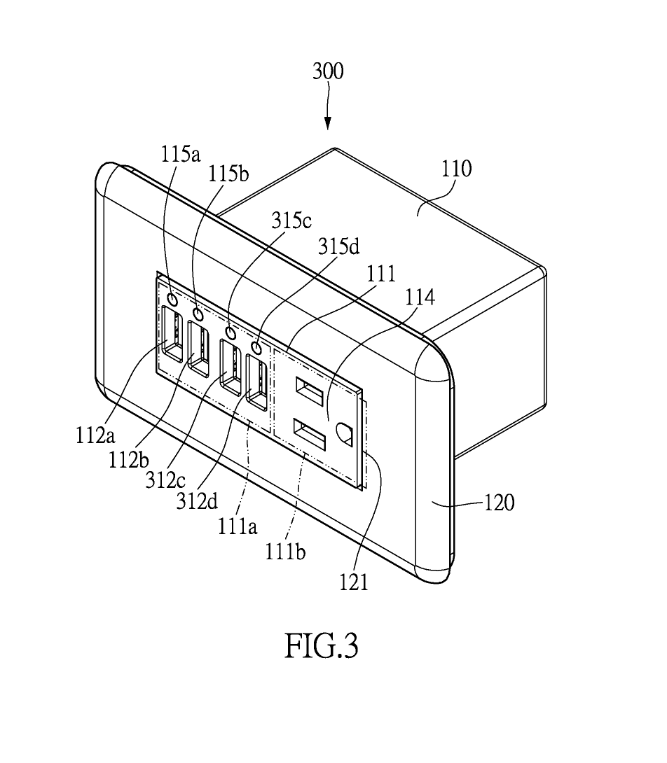

Please refer to FIG. 3, which shows a schematic diagram of the wall socket in accordance with another embodiment of the instant disclosure. As shown in FIG. 3, the instant embodiment differs from the embodiment in FIG. 1 in that the DC output area 111a of the wall socket 300 is disposed with at least four DC output sockets and at least four indicators, and the AC output area 111b of the wall socket 300 is merely disposed with the three-hole socket 114 but not disposed with the two-hole socket 113.

Specifically, the DC output area 111a is disposed with at least four DC output sockets, such as DC output sockets 112a, 112b, 312c, and 312b, and the DC output area 111a is disposed with at least four indicators, such as indicators 115a, 115b, 315c, 315d. In the instant embodiment, the DC output sockets 112a, 112b, 312c, and 312b are universal serial bus (USB) sockets, and the indicators 115a, 115b, 315c, 315d may be a light emitting diode (LED) or a plurality of LEDs. In addition, the DC output sockets 112a, 112b, 312c, and 312b and the three-hole socket 114 are arranged horizontally side by side. The indicators 115a, 115b, 315c, 315d are respectively disposed above the DC output sockets 112a, 112b, 312c, and 312b. The indicators 115a, 115b, 315c, 315d are respectively corresponding to the DC output sockets 112a, 112b, 312c, and 312b in one-to-one relationship. In the instant embodiment, the wall socket 100 includes four or more indicators and DC output sockets, and the ratio of indicators to DC output sockets is 1:1.

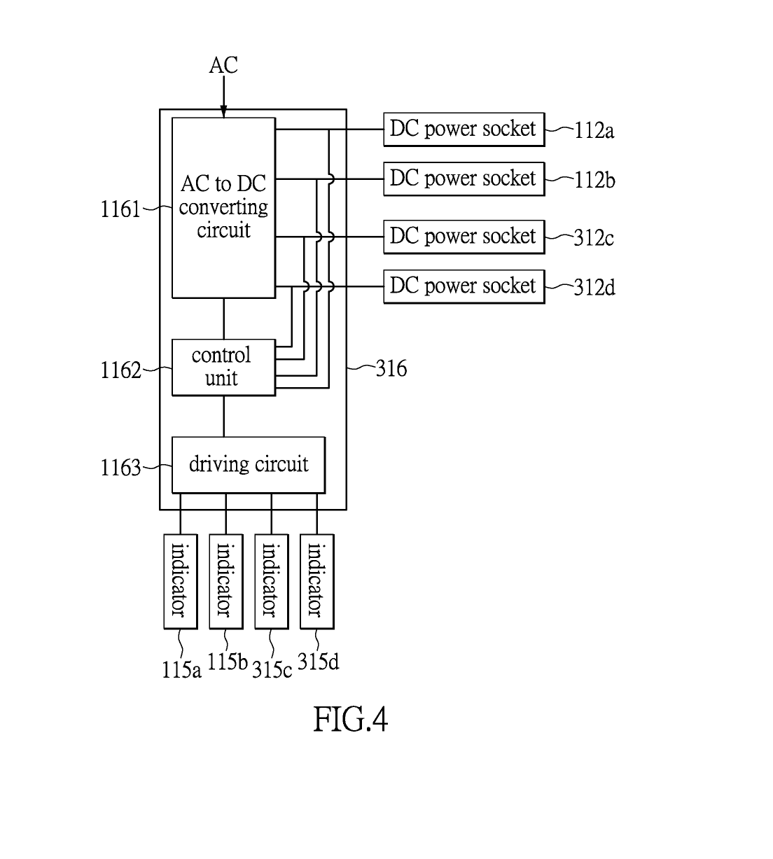

Please refer to FIG. 3 and FIG. 4, which shows a schematic diagram illustrating a power module connected to a plurality of indicators and a plurality of DC output sockets in accordance with another embodiment of the instant disclosure. As shown in FIG. 4, the instant embodiment differs from the embodiment in FIG. 2 in that the AC to DC converting unit 1161 is further coupled to DC output sockets 312c and 312d (i.e. the AC to DC converting unit 1161 is coupled to the AC terminal and the DC output sockets 112a, 112b, 312c, and 312d). The AC to DC converting unit 1161 supplies DC power to the AC terminal and the DC output sockets 112a, 112b, 312c, and 312d. It is worth noting that the wall socket 100 includes four or more indicators and DC output sockets, and the ratio of indicators to DC output sockets is 1:1.

Moreover, the driving circuit 1163 is further coupled to the indicators 315c and 315d (i.e. the driving circuit 1163 is coupled to the indicators 115a, 115b, 315c and 315d). The driving circuit 1163 is configured for driving the indicators 115a, 115b, 315c and 315d to be turned on or off. In addition, the control unit 1162 is further coupled to the DC output sockets 312c and 312d (i.e. the control unit 1162 is coupled to the AC to DC converting unit 1161, the driving circuit 1163, and the DC output sockets 112a, 112b, 312c, and 312d.). The control unit 1162 is configured for controlling the driving circuit 1163 to drive the indicators 115a, 115b, 315c and 315d according to a power state of the DC output sockets 112a, 112b, 312c, and 312d. Accordingly, when an electronic device is connected to the DC output sockets 112a, 112b, 312c, or 312d to receive the DC power from the DC output sockets 112a, 112b, 312c, or 312d, the control unit 1162 correspondingly controls the driving circuit 1163 to turn on the indicators 115a, 115b, 315c or 315d.

Similar operations of the wall socket 300 for the instant embodiment and the embodiments in FIGS. 1 and 2 are not repeated herein.

In summary, exemplary embodiments of the present disclosure provide a wall socket including the DC output sockets and the AC output sockets in order to supply the DC power and the AC power to different electronic devices. It is convenient for user to supply DC power to electronic devices directly through the wall socket but not through any AC/DC converter. Moreover, the socket panel of the wall socket is disposed with a plurality of indicators, and each of the indicators corresponds to each of the DC output sockets in one-to-one relationship. The indicators are turned on when the corresponding DC output socket supplies the DC power to an electronic device.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A wall socket, comprising:
a main body, having a socket portion, wherein the socket portion has a DC output area and an AC output area, the DC output area is disposed with at least two DC output sockets, the AC output area is disposed with a two-hole socket and a three-hole socket; and
a socket panel, disposed on the main body and having an opening to expose the socket portion;
wherein, the AC output area and the DC output area are arranged horizontally side by side, the two-hole socket is disposed between the DC output sockets and the three-hole socket.

2. The wall socket according to claim 1, wherein the main body has a receiving portion to accommodate a power module.

3. The wall socket according to claim 2, wherein the power module comprises:
an alternating current (AC) to direct current (DC) converting unit, coupled to an AC power terminal, and configured for transmitting a DC power to the DC output sockets;
a driving circuit, coupled to a plurality of indicators, and configured for driving the indicators; and
a control unit, coupled to the AC to DC converting unit and the driving circuit, and configured for controlling the indicators according to a power state of the DC output sockets.

4. The wall socket according to claim 1, further comprising at least two indicators, located above the DC output sockets, wherein each of the indicators is corresponding to each of the DC output sockets in one-to-one relationship.

5. The wall socket according to claim 1, wherein the DC output area is smaller than the AC output area.

6. The wall socket according to claim 1, wherein the DC output sockets are universal serial bus (USB) sockets.

7. A wall socket, comprising:
a main body, having a socket portion, wherein the socket portion has a DC output area and an AC output area, the DC output area is disposed with at least four DC output sockets, the AC output area is disposed with a three-hole socket; and
a socket panel, disposed on the main body and having an opening to expose the socket portion;
wherein, the AC output area and the DC output area are arranged horizontally side by side, the two-hole socket is disposed between the DC output sockets and the three-hole socket.

8. The wall socket according to claim 7, wherein the main body has a receiving portion to accommodate a power module.

9. The wall socket according to claim 8, wherein the power module comprises:
an alternating current (AC) to direct current (DC) converting unit, coupled to an AC power terminal, and configured for transmitting a DC power to the DC output sockets;
a driving circuit, coupled to a plurality of indicators, and configured for driving the indicators; and
a control unit, coupled to the AC to DC converting unit and the driving circuit, and configured for controlling the indicators according to a power state of the DC output sockets.

10. The wall socket according to claim 7, further comprising at least four indicators, located above the DC output sockets, wherein each of the indicators is corresponding to each of the DC output sockets in one-to-one relationship.
